(19) United States
(12) Patent Application Publication
(10) Pub. No.: US 2004/0110067 A1
(43) Pub. Date: Jun. 10, 2004

(54) Alloy for battery grids

(75) Inventor: M. Eric Taylor, Shorewood, WI (US)

Correspondence Address: FOLEY & LARDNER, 777 EAST WISCONSIN AVENUE, SUITE 3800, MILWAUKEE, WI, 53202-5308, US

(73) Assignee: Johnson Controls Technology Company

(21) Appl. No.: 10/314,041

(22) Filed: Dec. 6, 2002

(51) Int. Cl. H01M 4/68; C22C 11/06

(52) U.S. Cl. 429/245; 420/566; 420/565

(57) ABSTRACT

A lead alloy for use in battery grids include calcium in an amount between approximately 0.06 and 0.08 weight percent, tin in an amount between approximately 0.6 and 1.2 weight percent, and silver in an amount between approximately 0.005 and 0.015 weight percent.

### FIELD

The present invention relates generally to the field of lead alloys. The present invention relates more specifically to lead alloys for battery grids that include silver, calcium, and tin.

### BACKGROUND

Batteries (e.g., lead-acid storage batteries) typically include a number of cell elements that include positive and negative grids or plates and polymeric separators between the positive and negative grids. The grids are typically made of a lead alloy that includes various alloying elements intended to improve performance, life and/or manufacturability of the grids and battery.

It is generally known to provide any of a variety of alloying elements to improve performance, life, and/or manufacturability of positive battery grids. For example, it is known to add calcium to the alloy to increase hardness, which may improve grid manufacturability. Calcium in certain amounts, however, may result in increased corrosion of the grid due to formation of precipitated Pb₃Ca. It is also known to add silver to the alloy to increase mechanical strength (e.g., creep resistance) and hardening rate.

One known lead alloy including calcium and silver includes an alloy that consists essentially of about 0.06 to 0.08 weight percent calcium, about 0.3 to 0.6 weight percent tin, about 0.01 to 0.04 weight percent silver, about 0.01 to 0.04 weight percent copper, with the balance being lead. The ratio of tin to calcium for such known alloy ranges between 3.75:1 (for 0.3 percent tin and 0.08 percent calcium) and 10:1 (for 0.6 percent tin and 0.06 percent calcium). However, use of such known alloy results in formation of isolated regions of discontinuous precipitation (e.g., regions of Pb₃Ca), which may negatively impact the life of positive grids due to accelerated corrosion penetration and grid growth. (See U.S. Pat. No. 6,114,067.).

It is also known to provide a positive plate or grid for a lead-acid cell or battery that may be directly cast and which includes calcium present in an amount between 0.03 and 0.05 weight percent, tin in an amount between 0.65 and 1.25 weight percent, and silver in an amount between 0.018 and 0.030 weight percent. However, such known positive plates are relatively expensive to manufacture due to the relatively large amount of silver.

Accordingly, it would be advantageous to provide an improved lead alloy for use in battery grids that has acceptable corrosion rate and life. It would also be advantageous to provide a lead alloy that includes silver and calcium and that results in a reduced amount of discontinuous precipitation of Pb₃Ca during the life of battery grids made with the alloy. It would further be advantageous to provide a lead alloy that includes silver and has a suitable tin to calcium ratio. It would further be advantageous to provide a lead alloy for a battery grid that has a relatively high hardening rate. It would further be advantageous to provide a lead alloy for a battery grid that has a relatively high hardness and a relatively high strength. It would further be advantageous to provide a lead alloy for a battery grid that has suitable corrosion resistance and a relatively low corrosion rate. It would further be advantageous to provide a lead alloy for a battery grid that has relatively low hot cracking susceptibility. It would be desirable to provide for an alloy for battery grids having one or more of these or other advantageous features.

### SUMMARY

The present invention relates to a lead alloy for a battery grid. The lead alloy consists essentially of calcium in an amount between approximately 0.06 and 0.08 weight percent, tin in an amount between approximately 0.6 and 1.2 weight percent, and silver in an amount between approximately 0.005 and 0.015 weight percent.

The present invention also relates to an alloy for use in positive battery plates. The alloy consists essentially of calcium in an amount between 0.06 and 0.08 weight percent, tin in an amount between 0.6 and 1.2 weight percent, silver in an amount between 0.005 and 0.02 weight percent, and copper in an amount between 0.01 and 0.04 weight percent. The balance of the alloy comprises lead and the ratio of tin to calcium is greater than about 10 to 1.

The present invention further relates to a battery grid consisting essentially of silver between 0.005 and 0.02 weight percent, calcium between 0.06 and 0.08 weight percent, and tin between 0.6 and 1.2 weight percent. The ratio of tin to calcium is greater than approximately 10 to 1 and the balance of the battery grid consists essentially of lead.

### DETAILED DESCRIPTION OF PREFERRED AND OTHER EXEMPLARY EMBODIMENTS

A lead alloy for use in positive grids or plates used in batteries (e.g., lead-acid storage batteries) includes calcium, tin and silver according to an exemplary embodiment. According to an exemplary embodiment, the lead alloy may be used in a cast or book mold type battery grid or plate. According to other exemplary embodiments, the lead alloy may be used with wrought or other types of battery grids or plates.

The amount of calcium included in the lead alloy is selected to provide suitable hardness of the alloy, which may aid in manufacturability of the alloy, according to a preferred embodiment. Such suitable hardness of the alloy may reduce or eliminate the need for heat treatment of the lead alloy. The amount of calcium in the alloy should not be so great as to cause an unacceptable increase in corrosion rate. According to a preferred embodiment, aluminum may be included in the alloy (or in the melt pot of the alloy) to reduce the loss of calcium. For example, according to an exemplary embodiment, aluminum may be included in an amount up to approximately 0.025 weight percent. According to other exemplary embodiments, aluminum may be included in an amount of up to 0.02 weight percent.

The alloy includes calcium in an amount between approximately 0.06 and 0.08 percent by weight according to an exemplary embodiment. According to an alternative embodiment, the alloy includes calcium in an amount between approximately 0.065 and 0.075 weight percent.

The amount of tin in the alloy is selected to reduce corrosion according to a preferred embodiment. Without intending to be limited to any particular theory, it is believed that tin reacts with the calcium to form Sn₃Ca to inhibit the reaction of lead with the calcium, thereby reducing the formation of discontinuous Pb₃Ca precipitate (which may promote corrosion and grid growth).

The alloy includes tin in an amount between approximately 0.6 and 1.2 weight percent according to an exemplary embodiment. According to alternative embodiments, the alloy includes tin in an amount between approximately 0.7 and 1.0 weight percent or between approximately 0.6 and 0.9 weight percent.

The ratio of tin to calcium is selected to minimize the formation of Pb₃Ca precipitate according to a preferred embodiment. The ratio of tin to calcium is greater than about 10 to 1 according to a preferred embodiment, greater than about 12 to 1 according to other preferred or alternative embodiments, and greater than about 20 to 1 according to other preferred or alternative embodiments. According to one exemplary embodiment, the ratio of tin to calcium is between approximately 15 to 1 and 20 to 1.

The amount of silver in the alloy is selected to increase mechanical strength, including creep strength, according to a preferred embodiment. The amount of silver in the alloy is also selected to increase the hardening rates of the alloy according to a preferred embodiment.

The alloy includes silver in an amount between approximately 0.005 and 0.02 weight percent according to a preferred embodiment. The alloy includes silver in an amount between approximately 0.01 and 0.017 weight percent according to an alternative embodiment. The alloy includes silver in an amount between approximately 0.01 and 0.015 weight percent according to another alternative embodiment.

The alloy may include relatively low amounts of other materials according to other preferred or alternative embodiments. For example, the alloy may include background impurities or materials that are present in a commercially recycled lead stream. Relatively high amounts of impurities may cause drossing or unfavorable grain structure. Impurities in the lead alloy in the following amounts may be acceptable: (1) copper in an amount less than approximately 0.05 weight percent according to a preferred embodiment, copper in an amount less than approximately 0.04 weight percent according to an alternative embodiment, copper in an amount between approximately 0.1 and 0.4 weight percent according to other alternative embodiments; bismuth in an amount less than approximately 0.3 weight percent according to an alternative embodiment, bismuth in an amount less than approximately 0.025 weight percent according to other alternative embodiments; (3) arsenic in an amount less than approximately 0.002 weight percent according to an alternative embodiment, arsenic in an amount less than approximately 0.025 weight percent according to other alternative embodiments; (4) tellurium in an amount less than approximately 0.0003 weight percent according to an alternative embodiment, tellurium in an amount less than approximately 0.0001 weight percent according to other alternative embodiments.

According to an exemplary embodiment, the lead alloy includes silver in an amount between approximately 0.005 and 0.02 weight percent, calcium in an amount greater than approximately 0.06 weight percent, tin in an amount between approximately 0.6 and 1.2 weight percent, and copper in an amount between approximately 0.01 and 0.04 weight percent, with the balance being lead. The balance may also include other impurity elements (e.g., bismuth, arsenic, copper, silver, tellurium) in limited amounts.

According to a preferred embodiment, a lead alloy includes silver in an amount between approximately 0.01 and 0.015 weight percent, calcium in an amount between approximately 0.06 and 0.08 weight percent, tin in an amount between approximately 0.6 and 0.9 weight percent, and copper in an amount between approximately 0.01 and 0.04 weight percent, with the balance being lead and other additional elements that are present in recycled lead.

According to a preferred embodiment, the ratio of tin to calcium is greater than approximately 12 to 1. For example, where the alloy has a calcium content of approximately 0.07 weight percent, it is preferred that the tin content exceed approximately 0.84 weight percent. According to alternative embodiments, the ratio of tin to calcium may differ. For example, the tin to calcium ratio may be between approximately 15 to 1 and 20 to 1. It is believed that increasing the ratio of tin to lead reduces corrosion in grids by suppressing formation of precipitated Pb₃Ca, which in turn decreases grid growth and increases the life of the grids.

The weight percentages of the various alloying elements (e.g., calcium, tin, silver, copper) may vary according to alternative embodiments. For example, according to an alternative embodiment, silver may be present in an amount between approximately 0.005 and 0.015 weight percent. According to another alternative embodiment, tin may be present in an amount between approximately 0.7 and 1.1 weight percent.

It is also important to note that the construction and arrangement of the elements of the alloy for battery grids as shown in the preferred and other exemplary embodiments is illustrative only. Although only a few embodiments of the present inventions have been described in detail in this disclosure, those skilled in the art who review this disclosure will readily appreciate that many modifications are possible (e.g., variations in combinations and subcombinations of the alloying element amounts, variations in the amount of impurity or recycled elements present in the alloy, etc.) without materially departing from the novel teachings and advantages of the subject matter recited in the claims. For example, elements may be substituted and added, and the amounts of the elements may vary. Accordingly, all such modifications are intended to be included within the scope of the present invention as defined in the appended claims. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the preferred and other exemplary embodiments without departing from the spirit of the present inventions as expressed in the appended claims.

What is claimed is:

1. A lead alloy for a battery grid consisting essentially of:
calcium in an amount between approximately 0.06 and 0.08 weight percent;
tin in an amount between approximately 0.6 and 1.2 weight percent; and
silver in an amount between approximately 0.005 and 0.015 weight percent.

2. The lead alloy of claim 1 wherein the ratio of tin to calcium is greater than approximately 12 to 1.

3. The lead alloy of claim 1 wherein the alloy comprises between approximately 0.6 and 0.9 weight percent tin.

4. The lead alloy of claim 1 wherein the alloy comprises between approximately 0.7 and 1.0 weight percent tin.

5. The lead alloy of claim 1 wherein the alloy comprises copper in an amount less than approximately 0.05 weight percent.

6. The lead alloy of claim 5 wherein the copper is in an amount of about 0.01 weight percent to about 0.04 weight percent.

7. An alloy for use in positive battery plates consisting essentially of:
calcium in an amount between 0.06 and 0.08 weight percent;
tin in an amount between 0.6 and 1.2 weight percent;
silver in an amount between 0.005 and 0.02 weight percent; and
copper in an amount between 0.01 and 0.04 weight percent;
wherein the balance of the alloy comprises lead and wherein the ratio of tin to calcium is greater than about 10 to 1.

8. The alloy of claim 7, wherein the alloy comprises between approximately 0.6 and 0.9 weight percent tin.

9. The alloy of claim 7, wherein the alloy comprises between 0.005 and 0.015 weight percent silver.

10. The alloy of claim 9, wherein the ratio of tin to calcium is greater than approximately 12 to 1.

11. The alloy of claim 7, further comprising at least one of bismuth, arsenic, and tellurium.

12. A battery grid consisting essentially of:
silver between 0.005 and 0.02 weight percent;
calcium between 0.06 and 0.08 weight percent; and
tin between 0.6 and 1.2 weight percent;
wherein the ratio of tin to calcium is greater than approximately 10 to 1; and
wherein the balance of the battery grid consists essentially of lead.

13. The battery grid of claim 1 2, wherein the tin content is between 0.6 and 0.9 weight percent.

14. The battery grid of claim 1 3, wherein the silver content is between 0.010 and 0.015 weight percent.

15. The battery grid of claim 12, wherein ratio of tin to calcium is greater than approximately 12 to 1.

16. The battery grid of claim 1 2, wherein ratio of tin to calcium is between approximately 15 to 1 and 20 to 1.

17. The battery grid of claim 12, further comprising between 0.01 and 0.04 weight percent copper.

18. A method of producing an alloy for use in battery plates, the method comprising:
alloying a lead material with calcium, tin, and silver to produce a lead alloy;
wherein the lead alloy comprises between 0.06 and 0.08 weight percent calcium, between 0.6 and 1.2 weight percent tin, between 0.005 and 0.02 weight percent silver, and between 0.01 and 0.04 weight percent copper; and
wherein the ratio of tin to calcium in the lead alloy exceeds approximately 12 to 1.

19. The method of claim 1 7, wherein the lead alloy comprises at least one of bismuth, tellurium, and arsenic in an amount not greater than approximately 0.0025 weight percent.

20. The method of claim 1 7, wherein the lead alloy comprises between 0.6 and 0.9 weight percent tin.

21. The method of claim 17, wherein the lead alloy comprises between 0.005 and 0.015 weight percent silver.

22. The method of claim 1 7, wherein the ratio of tin to calcium is between approximately 15 to 1 and 20 to 1.
